(19) United States
(12) Patent Application Publication
(10) Pub. No.: US 2002/0014908 A1
(43) Pub. Date: Feb. 7, 2002

(54) Device for voltage multiplication with high efficiency, combination of the device with a battery-operated apparatus, and low-power loss generation of a programming voltage

(76) Inventor: Christl Lauterbach, Hohenkirchen-Siegertsbrunn (DE)

Correspondence Address: LERNER AND GREENBERG, P.A., PATENT ATTORNEYS AND ATTORNEYS AT LAW, Post Office Box 2480, Hollywood, FL, 33022-2480, US

(21) Appl. No.: 09/886,557

(22) Filed: Jun. 21, 2001

Related U.S. Application Data
(63) Continuation of application No. PCT/DE99/04054, filed on Dec. 21, 1999.

(30) Foreign Application Priority Data
Dec. 21, 1998 (DE) 198 59 131.4
Jun. 11, 1999 (DE) 199 26 700.6

(51) Int. Cl. G05F 3/02

(52) U.S. Cl. 327/536

(57) ABSTRACT

The device for voltage multiplication on the basis of a boosted charge pump is used, for example, as on-chip high-voltage generator in EEPROMs and flash EEPROMs. As a result of charging the pump capacitances via tristate drivers and a simplified timing scheme, the power loss is reduced and chip area is saved.

### Cross-Reference to Related Application

This application is a continuation of copending International Application PCT/DE99/04054, filed Dec. 21, 1999, which designated the United States.

### Background of the Invention

1. Field of the Invention

The invention relates to a device for voltage multiplication which operates according to the principle of the charge pump, such a charge pump comprising at least two pump transistors and two boost transistors and also four capacitors and having a four-phase timing scheme. Such devices are often monolithically integrated on the semiconductor chip of electrically programmable read-only memories, such as EEPROMS and flash EEPROMs, for example. Devices of this type are disclosed in the commonly assigned, published international PCT application WO 97/26657, in U.S. Pat. No. 6,172,886 (see published PCT application WO 98/01938), and also in a publication at the IEEE conference ESSCIRC 98 in September 1998. U.S. Pat. No. 5,818,289 describes a circuit having so-called charge sharing between the pump capacitances. With this pump driving, the efficiency is increased by virtue of the fact that, unlike in the case of the pump principle described above, a charged pump capacitance is not discharged to ground, rather the charge is brought via a switch to the nearest capacitance, the latter being charged from 0V to Vdd/2. The first capacitance is then likewise at Vdd/2 and only this charge is dissipated to ground. In this way, it is possible to save 50% of the energy that has to be supplied by the source for charging the capacitances. What is disadvantageous in this case is a relatively complex timing scheme with five clock signals that are separated from one another with respect to time.

### Summary of the Invention

The object of the present invention is to provide a voltage multiplier which overcomes the above-noted deficiencies and disadvantages of the prior art devices and methods of this general kind, and which specifies a device for voltage multiplication wherein the overall efficiency of the pump is as high as possible and at the same time the required chip area is as small as possible.

With the above and other objects in view there is provided, in accordance with the invention, a device for voltage multiplication, comprising:

a first pump voltage terminal, a second pump voltage terminal, a first boost voltage terminal, and a second boost voltage terminal;

a charge pump having

a plurality of boost transistors including odd-numbered boost transistors and even-numbered boost transistors, the odd-numbered boost transistors having gates connected to the first pump voltage terminal via pump capacitors and the even-numbered boost transistors having gates connected to the second pump voltage terminal via further pump capacitors;

a plurality of pump transistors including odd-numbered pump transistors and even-numbered pump transistors, the odd-numbered pump transistors having gates connected to the first boost voltage terminal via capacitors and the even-numbered pump transistors having gates connected to the second boost voltage terminal via capacitors;

a first tristate driver having an output connected to the first pump voltage terminal and a second tristate driver having an output connected to the second pump voltage terminal, the first and second tristate drivers having inputs connected to the first and second boost voltage terminals, and wherein a high-impedance state is present at each of the outputs of the first and second tristate drivers when the first and second boost voltage terminals carry boost voltages of substantially equal magnitude.

In accordance with an added feature of the invention, a connecting transistor is connected between the first and second pump voltage terminals, the connecting transistor having a gate driven in dependence on the boost voltages such that the connecting transistor is in an on state if neither the pump transistors nor the boost transistors are in an on state.

In accordance with an additional feature of the invention, a NOR gate is provided with a first input connected to the first boost voltage terminal, a second input connected to the second boost voltage terminal, and an output connected to the gate of the connecting transistor.

In accordance with another feature of the invention, the second boost voltage is formed by feeding a global clock signal to a NOR gate such that the global clock signal is fed directly to a first input and is fed to a further input after having been delayed by a delay element, and the boost voltage is present at the output of the NOR gate, and the first boost voltage is formed by feeding the global clock signal to an AND logic such that the global clock signal is fed directly to a first input and is fed to a further input after having been delayed by a delay element, and the boost voltage is present at the output of the AND logic.

In accordance with again another feature of the invention, the AND logic is formed by a further NOR gate having inverting inputs.

In accordance with a concomitant feature of the invention, a respective tristate driver has a p-channel transistor between a first supply voltage terminal and the output of the tristate driver, and an n-channel transistor between reference-ground potential and the output;

the p-channel transistor has a gate connected to the first boost voltage terminal via an inverting driver; and

the n-channel transistor has a gate connected to the second boost voltage terminal via a non-inverting driver.

With the above and other objects in view there is also provided, in accordance with the invention, a combination of a battery-operated apparatus with the above-outlined device, wherein the device is used for low-power-loss generation of a programming voltage for an electrically programmable read-only memory of the battery-operated apparatus.

There is also provided a method of generating a programming voltage with low power loss, which comprises connecting the above-outlined device in a battery-operated apparatus and generating therewith a programming voltage for an electrically programmable read-only memory of the battery-operated apparatus.

Other features which are considered as characteristic for the invention are set forth in the appended claims.

Although the invention is illustrated and described herein as embodied in a device for voltage multiplication with high efficiency, and its use, it is nevertheless not intended to be limited to the details shown, since various modifications and structural changes may be made therein without departing from the spirit of the invention and within the scope and range of equivalents of the claims.

The construction and method of operation of the invention, however, together with additional objects and advantages thereof will be best understood from the following description of specific embodiments when read in connection with the accompanying drawings.

### Brief Description of the Drawings

FIG. 1 is a circuit diagram of a first embodiment a device for voltage multiplication with high efficiency;

FIG. 1A is a circuit diagram of a second embodiment the device for voltage multiplication;

FIG. 2 is a detailed circuit schematic of the tristate circuits of FIG. 1;

FIG. 2A is a detail circuit schematic of the interconnected tristate circuits in the second embodiment of FIG. 1A;

FIGS. 3 and 4 are each voltage timing diagrams referring back to the devices of FIGS. 1, 1A, 2, and 2A;

FIG. 5 is a diagram of a detail of a circuit for generating two clock voltages from FIGS. 1, 1A, 2, and 2A; and

FIG. 6 is a chart of a comparative illustration of the efficiency of prior art devices and for two exemplary embodiments of the invention.

### Description of the Preferred Embodiments

The invention achieves a significant improvement in the efficiency, in particular at low output currents, both in the case of the conventional charge pump with four clock signals and in the case of the charge pump with charge sharing. This is achieved both by the simplified clock generation with two clock signals, which itself requires less energy, and by fewer parasitic current peaks during pumping, said peaks being produced by capacitive over coupling at the pump and boost capacitances. In this case, the output power of the pump is not impaired and the output voltage even increases at low output currents. The simplified timing scheme means that, for an identical pump power, there is also a reduction in the required chip area. A smaller number of current peaks means that the electromagnetic emission for circuits with charge pumps is improved.

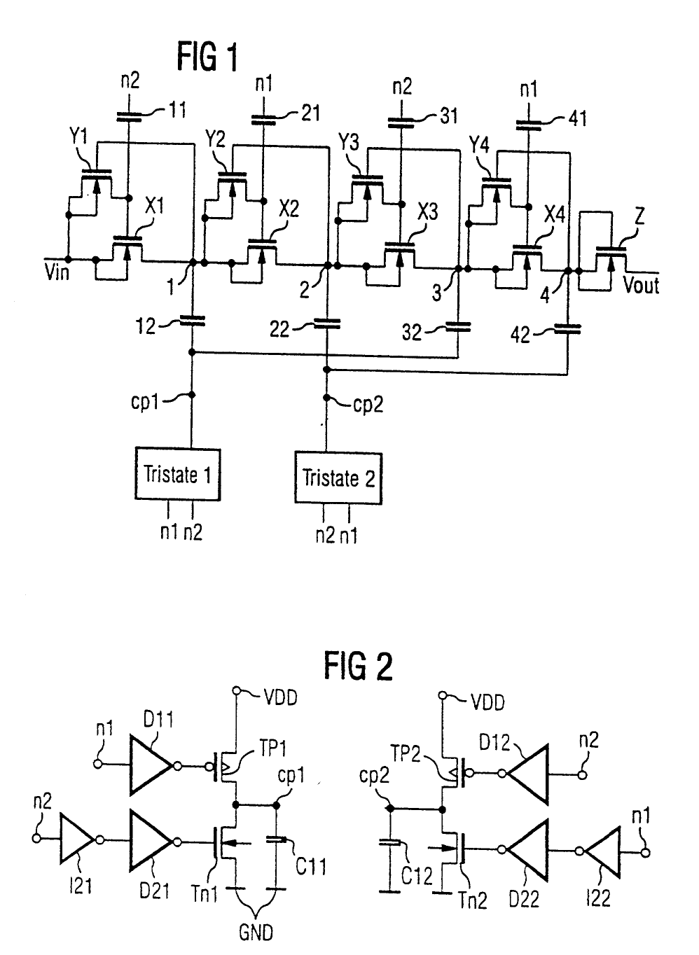

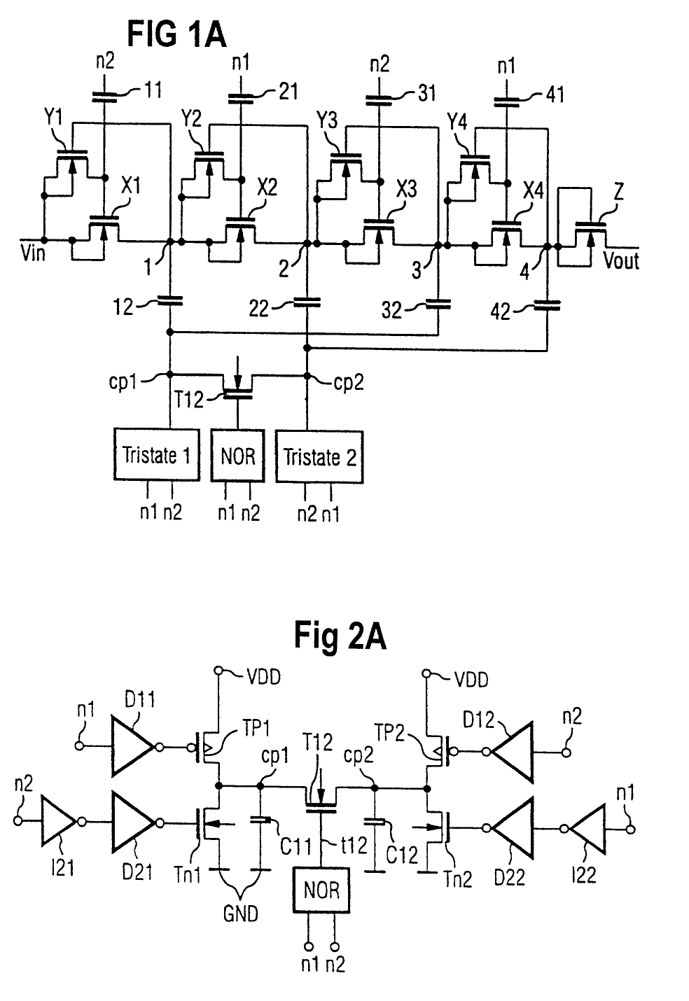

Referring now to the figures of the drawing in detail and first, particularly, to FIGS. 1 and 1A thereof, there is seen an exemplary device for voltage multiplication which has four identically constructed stages and forms from low input voltage Vin a high output voltage Vout in dependence on four clock voltages n1, n2, cp1 and cp2. The charge pump illustrated in this example serves for generating a positive output voltage Vout. The pump has a pump transistor X1, a boost transistor Y1, and capacitors 11 and 12 in a first stage, a pump transistor X2, a boost transistor Y2, and capacitors 21 and 22 in a second stage, a pump transistor X3, a boost transistor Y3, and capacitors 31 and 32 in a third stage, and also a pump transistor X4, a boost transistor Y4, and capacitors 41 and 42 in a fourth stage.

In the first stage, a first terminal of the transistor X1 is connected to a terminal for the input voltage Vin, a second terminal of the pump transistor X1 is connected to a first terminal of the pump transistor X2 of the second stage, and the gate of the pump transistor X1 is connected to a terminal for a first boost clock voltage n2 via the capacitor 11. Furthermore, the gate of the pump transistor X1 is connected to the terminal for the input voltage Vin via the boost transistor Y1, whose gate is connected to the connecting node 1 between the pump transistors X1 and X2, which, in turn, is connected via the capacitor 12 to a terminal for a first pump clock voltage cp1.

In the second stage, the pump transistor X2 is connected to a first terminal of the pump transistor X3 of the third stage via a connecting node 2 and the gate of the pump transistor X2 is connected to a terminal for the second boost clock voltage n1 via the capacitor 21 and to the connecting node 1 via the boost transistor Y2. The gate of the boost transistor Y2 is connected to the connecting node 2 and the latter is connected via the capacitor 22 to a terminal for the pump clock voltage cp2.

In the third stage, the pump transistor X3 is connected to a first terminal of the fourth pump transistor X4 of the fourth stage via a connecting node 3 and the gate of the pump transistor X3 is connected to the first boost clock voltage n2 via the capacitor 31 and to the connecting node 2 via the boost transistor Y3. The gate of the boost transistor Y3 is connected to the connecting node 3, which is connected via the capacitor 32 to a terminal for the pump clock voltage cp1. The pump transistor X4 of the fourth stage is connected by its second terminal to a first terminal and to the gate terminal of an end transistor Z, whose second terminal carries the output voltage Vout. The gate of the pump transistor X4 is connected to a terminal for the second boost clock voltage n1 via the capacitor 41 and to the connecting node 3 via the boost transistor Y4. The gate of the boost transistor Y4 is connected to the connecting node 4, which, in turn, is connected via the capacitor 42 to a terminal for the second pump clock voltage cp2.

The terminal for the first pump clock voltage cp1 is connected to the output of a first tristate gate Tristatel, whose first input is connected to the terminal for the boost clock voltage n1 and whose second input is connected to the terminal for the second boost clock voltage n2. The terminal for the second pump clock voltage cp2 is connected to the output of a second tristate gate Tristate2, whose first input is connected to the terminal for the second boost clock voltage n2 and whose second input is connected to the terminal for the first pump clock voltage n1, a pump clock voltage cp2 which is the inverse of the first pump clock voltage cp1 being produced as a result of the inputs being interchanged in comparison with the tristate gate Tristatel. From FIG. 1 it becomes clear inter alia that, advantageously, only two clock voltages n1 and n2 have to be formed or fed in, since the other two clock voltages cpl and cp2 are formed anyway in the device, which simplifies the pulse generation for the actual charge pump.

With reference to FIG. 1A, in the case of a pump according to the charge sharing principle, all that is additionally present as compared to FIG. 1, is a connecting transistor T12 between the terminal for the first pump clock voltage cp1 and the terminal for the second pump clock voltage cp2. The gate of the connecting transistor T12 is connected to the output of a NOR gate NOR, a first input of the NOR gate being connected to the terminal for the first boost clock voltage nl and a second terminal of the NOR gate being connected to the terminal for the second boost clock voltage n2.

FIG. 2A illustrates the section with the optionally present connecting transistor T12 and NOR gate and also the tristate gates from FIGS. 1 and 1A in the form of an exemplary embodiment. In this case, the tristate gate Tristatel has a p-channel transistor Tp1 between a first supply voltage terminal VDD and the terminal for the first pump clock voltage cp1, and an n-channel transistor Tn1 between the terminal for the first pump clock voltage cp1 and reference-ground potential GND. The gate of the transistor Tp1 is connected to the terminal for the boost voltage n1 via an inverting driver D11 and the gate of the transistor Tn1 is connected to the terminal for the boost clock voltage n2 via a non-inverting driver, which in this case comprises by way of example an inverting driver D21 and an inverter connected upstream. The tristate gate Tristate2 has a p-channel transistor Tp2 between the terminal for the pump clock voltage cp2 and the supply voltage VDD, and an n-channel transistor Tn2 between the terminal for the pump clock voltage cp2 and reference-ground potential. The gate of the transistor Tp2 is connected to the terminal for the boost clock voltage n2 via an inverting driver D12 and the gate of the transistor Tn2 is connected to the terminal for the boost clock voltage n1 via a non-inverting driver, which is in this case formed from an inverting driver D22 and an inverter D22 connected upstream. An equivalent capacitance CI1 is depicted between the reference-ground potential and the terminal for the pump clock voltage cp1 and an equivalent capacitance CI2 is in this case depicted between the terminal for the pump clock voltage cp2 and reference-ground potential, said capacitances essentially representing the capacitances 12, 22, 32 and 42.

As in FIG. 1A, the transistor T12 is present between the terminals for the clock voltages cp1 and cp2, the clock voltage t12 formed by the NOR gate NOR being present at the gate of said transistor T12.

The tristate drivers mean that it is possible to omit the generation of the pump clock voltages cp1 and cp2 since the boost clock voltages (boost pulses) simultaneously serve as driving for the tristate drivers Tristatel and Tristate2. Furthermore, the tristate drivers prevent recharging of the pump capacitances CI1 and CI2 during the boost cycle in the charge pump by virtue of the fact that after the charging of the pump capacitances, the driver acquires a high impedance. Since the recharging of the pump capacitances requires energy which does not contribute to the voltage boosting in the pump, already a lower power loss is generated just by virtue of the tristate drivers in comparison with the prior art.

The connecting transistor T12 and the NOR gate NOR enable the power loss of the device for voltage multiplication to be further reduced and thus for the efficiency to be further increased. In this case, a quarter of the energy is “conserved” through charge reversal of the pump capacitances CI1 and CI2. The energy savings brought about by this means enables the driver transistors in the tristate drivers Tristatel and Tristate2 to be reduced by half, which saves chip area.

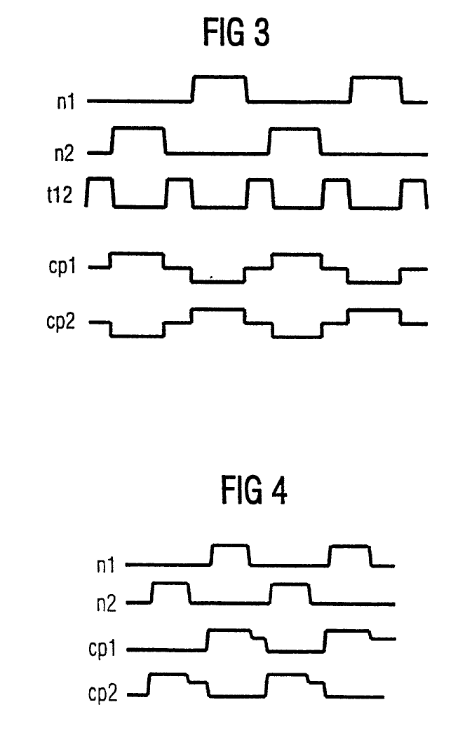

FIG. 3 illustrates a voltage timing diagram for the clock voltages n1, n2, t12, cp1 and cp2 of a pump according to the charge sharing principle. In order that a high-impedance state can be established in the tristate drivers Tristatel and Tristate2, the two clock voltages n1 and n2 must not be the inverse of one another, but rather must have an overlap region with a common level, in this case approximately 0 volts, for example. The NOR gate produces the drive voltage t12 for the connecting transistor T12, which in this case has a high level in the overlap region of the voltages n1 and n2 in order that the transistor T12 can momentarily effect charge balancing between the charging of the first pump capacitance CI1 and the charging of the second pump capacitance CI2. The two clock voltages cp1 and cp2 have stepped waveforms and are the inverse of one another, the two clock voltages having a common intermediate level of VDD/2 in the overlap region, that is to say when the voltage T12 has a high level.

FIG. 4 illustrates a voltage timing diagram for the clock voltages n1, n2, cp1 and cp2 of a pump without charge sharing. In this case, too, the two clock voltages n1 and n2 must not be the inverse of one another, but rather must have an overlap region with a common level, in this case approximately 0 volts, for example. The two clock voltages cp1 and cp2 are largely the inverse of one another, the two clock voltages having, in the case of the high level in the overlap region, a somewhat lower voltage than the voltage of the other high level.

FIG. 5 shows by way of example a circuit for generating the clock signals n1 and n2 from a global clock signal CLK. In this case, the global clock signal CLK is fed to a NOR gate NOR1 in such a way that it is fed directly to a first input and is fed to a further input after having been delayed by a delay element, and the clock signal n1 is present at the output of the NOR gate NOR1. The inputs of a NOR gate NOR2 are connected up correspondingly, but in an inverted fashion, and the signal n2 is present at the output of the NOR gate NOR2. The input-side inversions together have the function of an AND gate.

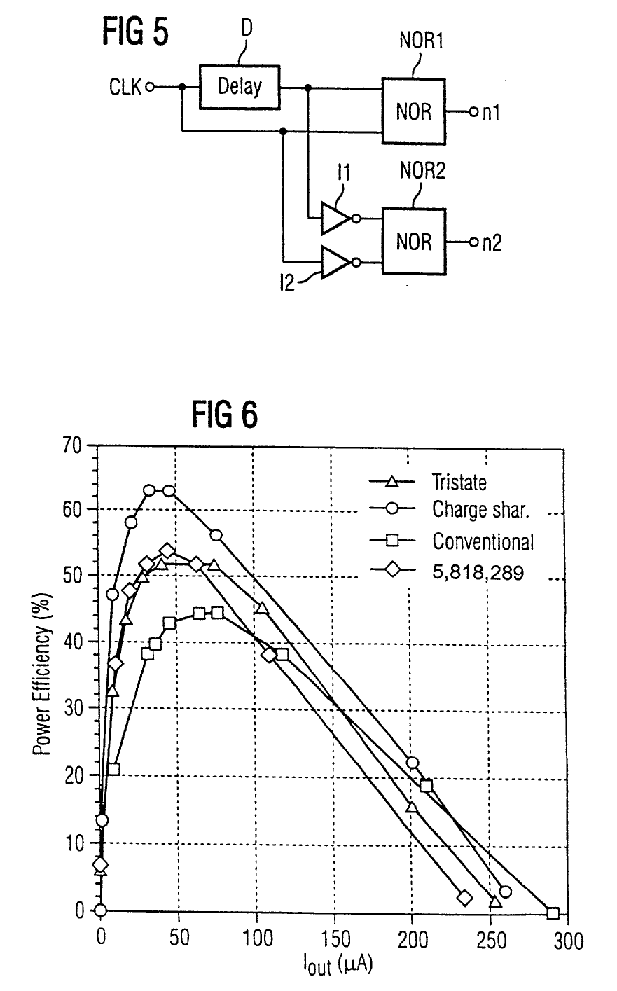

FIG. 6 illustrates the efficiency as a function of the output current for a customary device for voltage multiplication without charge sharing “conventional” and one with charge sharing in accordance with U.S. Pat. No. 5,818,289 and also for an exemplary embodiment according to the invention of the device for voltage multiplication without charge sharing “tristate” and one with charge sharing “charge shar.”. It is apparent in this case that there are considerable differences between the devices for voltage multiplication precisely in the region of maximum efficiency. Given an identical pump layout and identical clock frequency, the driving according to the invention of a charge pump without charge sharing increases the maximum efficiency from 45% to 52%. In the case of pumps with charge sharing (5,818,289), the driving according to the invention increases the efficiency from 54% to 63%. In this case, the current yield at relatively high currents is additionally improved by almost 10%.

Devices of this type can, of course, be used not only in connection with the charge pump described here for generating a positive output voltage Vout, but also in connection with a charge pump for generating a negative output voltage, as described in the prior art mentioned in the introduction, for instance WO 97/26657.

Such a device for voltage multiplication can advantageously be used for generating the programming voltage, which is relatively high in comparison with the supply voltage, in an electrically programmable read-only memory, such as, for example, EEPROMs and flash EEPROMs, the device preferably being monolithically integrated on the semiconductor chip of said read-only memory. Read-only memories having such a device can preferably be used in battery-operated apparatuses.

I claim:

1. A device for voltage multiplication, comprising:
a first pump voltage terminal, a second pump voltage terminal, a first boost voltage terminal, and a second boost voltage terminal;
a charge pump having
a plurality of boost transistors including odd-numbered boost transistors and even-numbered boost transistors, said odd-numbered boost transistors having gates connected to said first pump voltage terminal via pump capacitors and said even-numbered boost transistors having gates connected to said second pump voltage terminal via further pump capacitors;
a plurality of pump transistors including odd-numbered pump transistors and even-numbered pump transistors, said odd-numbered pump transistors having gates connected to said first boost voltage terminal via capacitors and said even-numbered pump transistors having gates connected to said second boost voltage terminal via capacitors;
a first tristate driver having an output connected to said first pump voltage terminal and a second tristate driver having an output connected to said second pump voltage terminal, said first and second tristate drivers having inputs connected to said first and second boost voltage terminals, and wherein a high-impedance state is present at each of said outputs of said first and second tristate drivers when said first and second boost voltage terminals carry boost voltages of substantially equal magnitude.

2. The device according to claim 1, which comprises a connecting transistor connected between said first and second pump voltage terminals, said connecting transistor having a gate driven in dependence on the boost voltages such that said connecting transistor is in an on state if neither said pump transistors nor said boost transistors are in an on state.

3. The device according to claim 2, which comprises a NOR gate having a first input connected to said first boost voltage terminal, a second input connected to said second boost voltage terminal, and an output connected to said gate of said connecting transistor.

4. The device according to claim 1, wherein:
said second boost voltage terminal carries a boost voltage formed by feeding a global clock signal to a NOR gate such that the global clock signal is fed directly to a first input and is fed to a further input after having been delayed by a delay element, and the boost voltage is present at said output of said NOR gate, and
said first boost voltage terminal carries a boost voltage formed by feeding the global clock signal to an AND logic such that the global clock signal is fed directly to a first input and is fed to a further input after having been delayed by a delay element, and the boost voltage is present at the output of the AND logic.

5. The device according to claim 1, wherein said AND logic is formed by a further NOR gate having inverting inputs.

6. The device according to claim 1, wherein a respective tristate driver has a p-channel transistor between a first supply voltage terminal and said output of said tristate driver, and an n-channel transistor between reference-ground potential and said output,
said p-channel transistor has a gate connected to said first boost voltage terminal via an inverting driver; and
said n-channel transistor has a gate connected to said second boost voltage terminal via a non-inverting driver.

7. In combination with a battery-operated apparatus, the device according to claim 1 for low-power-loss generation of a programming voltage for an electrically programmable read-only memory of the battery-operated apparatus.

8. A method of generating a programming voltage with low power loss, which comprises connecting the device according to claim in a battery-operated apparatus and generating, with the vice according to claim 1, a programming voltage for an electrically programmable read-only memory of the battery-operated apparatus.
